(19) United States
(12) Patent Application Publication
(10) Pub. No.: US 2020/0209440 A1
(43) Pub. Date: Jul. 2, 2020

(54) CAMERA LENS AND ELECTRONIC DEVICE HAVING IMAGE SHOOTING FUNCTION

(71) Applicant: AAC Optics Solutions Pte. Ltd., Singapore City (SG)

(72) Inventor: Lingyun Xu, Shenzhen (CN)

(21) Appl. No.: 16/708,439

(22) Filed: Dec. 10, 2019

(30) Foreign Application Priority Data
Dec. 27, 2018 (CN) 201822246091.3

(51) Int. Cl. G02B 5/00; G02B 9/60; G02B 13/00; G02B 7/02

(52) U.S. Cl. CPC G02B 5/003; G02B 7/021; G02B 13/0045; G02B 9/60

(57) ABSTRACT

The present invention provides a camera lens and an electronic device having image shooting function, wherein the camera lens includes a lens barrel, a first lens, a second lens and a first light shielding sheet. The first lens, the first light shielding sheet and the second lens are stacked in the lens barrel in sequence from an object side to an image side, the lens barrel has a first annular inclined surface surrounding a periphery of the first light shielding sheet, the first annular inclined surface is provided with a glue layer, and an outer edge of the first light shielding sheet is adhered to the glue layer.

### TECHNICAL FIELD

The present invention relates to the field of optical imaging technologies, and more particularly, to a camera lens and an electronic device having image shooting function.

### BACKGROUND

In recent years, with the development of imaging technologies and the rise of electronic products with imaging function, optical camera lenses have been widely used in various products. A camera lens in the prior art includes a lens barrel with an accommodating space, a plurality of lenses accommodated in the accommodating space and a light shielding sheet arranged between two adjacent lenses, wherein the plurality of lenses are assembled together in a stacked manner, and the lenses are limited in the lens barrel through a pressure ring glued on an inner wall of the lens barrel.

The current light shielding sheets are all assembled in the camera lens through a adsorption pen. However, when the inner side wall of the lens barrel has an annular inclined surface structure, the light shielding sheet on the annular inclined surface is easily to be taken out by the adsorption pen during assembly process, resulting in the deviation of the light shielding sheet.

Therefore, it is necessary to provide a camera lens to solve the problem that the light shielding sheet on the annular inclined surface in the current camera lens is easily to be taken out by the adsorption pen, which cause the deviation of the light shielding sheet.

### BRIEF DESCRIPTION OF THE DRAWINGS

FIG. 1 is a main sectional view of a camera lens according to the present invention.

FIG. 2 is a partial enlarged drawing of a portion A in FIG. 1.

FIG. 3 is a partial enlarged drawing of a portion B in FIG. 1.

In the figures: 1 refers to camera lens; 10 refers to lens barrel; 11 refers to first annular inclined surface; 20 refers to lens group; 21 refers to first lens; 22 refers to second lens; 23 refers to third lens; 231 refers to annular recess; 232 refers to side wall; 233 refers to bottom wall; 24 refers to fourth lens; 241 refers to annular lug boss; 242 refers to second annular inclined surface; 25 refers to fifth lens; 30 refers to first light shielding sheet; 40 refers to glue layer; 50 refer to second light shielding sheet; 60 refers to third light shielding sheet; 70 refers to light shielding plate; 80 refers to fourth light shielding sheet; 90 refers to fifth light shielding sheet; and 100 refers to pressure ring.

### DETAILED DESCRIPTION

The present invention is further described hereinafter with reference to the drawings and embodiments.

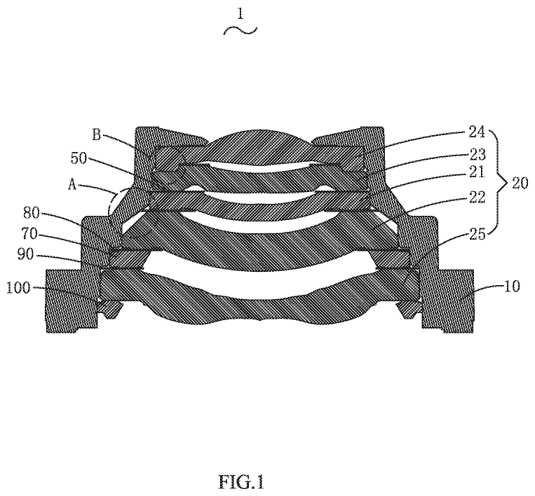

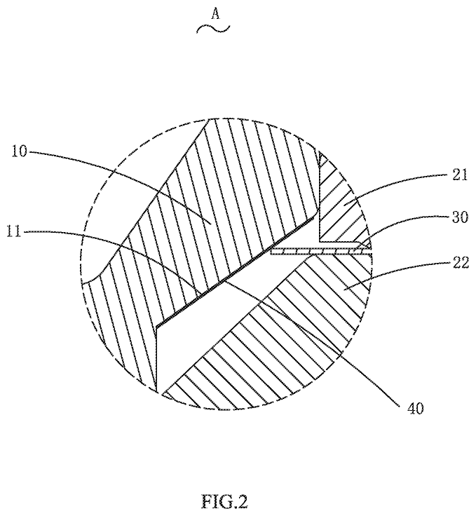

Referring to FIGS. 1 to 2, the embodiments of the present invention provide a camera lens 1. The camera lens 1 includes a lens barrel 10 and a lens group 20 accommodated in the lens barrel 10. The lens group 20 includes a first lens 21 and a second lens 22 stacked in sequence from an object side to an image side. The lens 1 further includes a first light shielding sheet 30 which is arranged between the first lens 21 and the second lens 22 and is located at a connection position of the first lens 21 and the second lens 22. When light is irradiated to the connection position of the first lens 21 and the second lens 22, the light will be absorbed by the first light shielding sheet 30 to prevent stray light from being generated when the light is irradiated from the first lens 21 to a fixing portion on the second lens 22. In this embodiment, a first annular inclined surface 11 surrounding a periphery of the first light shielding sheet 30 is arranged at a middle position of an inner side wall of the lens barrel 10. In order to stably fix the first light shielding sheet 30 on the first annular inclined surface 11 in the lens barrel 10, a glue layer 40 is coated on the first annular inclined surface 11, the glue layer 40 is an adhesive layer, and one end portion of the first light shielding sheet 30 facing towards the first annular inclined surface 11 is bonded with the adhesive layer 40. In this way, the first light shielding sheet 30 on the first annular inclined surface 11 can be prevented from being taken out by a adsorption pen while assembling the camera lens 1, so that the first light shielding sheet 30 can be stably fixed on the first annular inclined surface 11 in the camera lens 1 without deviation; and meanwhile, since the first light shielding sheet 30 is fixed on the first annular inclined surface 11 through the glue layer 40, the manufacturing requirement on edges of the first light shielding sheet 30 can be reduced and the manufacturing cost of the first light shielding sheet 30 can be reduced when the first light shielding sheet 30 is manufactured.

The lens group 20 further includes a third lens 23 and a fourth lens 24 arranged on an object side of the first lens 21, and the third lens 23 is located between the fourth lens 24 and the first lens 21. In order to prevent the light from being irradiated from the third lens 23 to a fixing portion of the first lens 21 to generate stray light, a second light shielding sheet 50 is arranged between the third lens 23 and the first lens 21. In order to prevent the light from being irradiated from the fourth lens 24 to a fixing portion of the third lens 23, a third light shielding sheet 60 is arranged between the fourth lens 24 and the third lens 23.

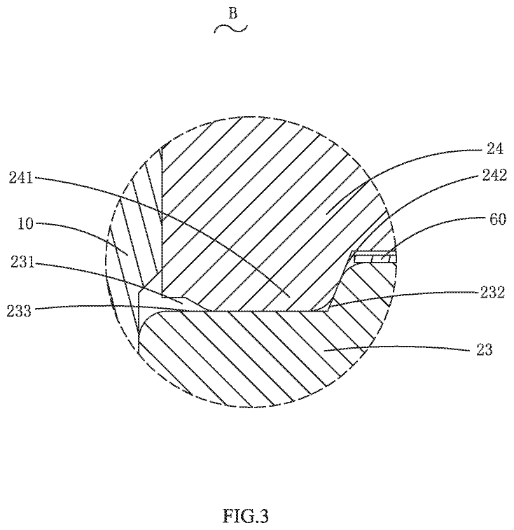

Further referring to FIG. 3, preferably, an outer edge of the object side of the third lens 23 is provided with an annular recess 231, and outer edge of an image side of the fourth lens 24 is provided with an annular lug boss 241, and the annular lug boss 241 is clamped in the annular recess 231. In this way, by arranging the annular lug boss 241 on the fixing portion of the fourth lens 24 and arranging the annular recess 231 for insertion of the annular lug boss 241 on the fixing portion of the third lens 23, the matching stability of the third lens 23 and the fourth lens 24 is facilitated.

Preferably, the annular recess 231 is defined cooperatively by a side wall 232 and a bottom wall 233, the side wall 232 and the bottom wall 233 are arranged outwards along a radial direction of the lens barrel 10, the side wall 232 obliquely extends to the bottom wall 233 in a manner of gradually away from a central line of the lens barrel 10, and the annular lug boss 241 has a second annular inclined surface 242 attached to the side wall 232.

By configuring inclined surface at the position where the annular lug boss 241 and the side wall 232 attached to each other, when the third lens 23 and the fourth lens 24 are combined, a central line of the third lens 23 and a central line of the fourth lens 24 can be kept collineated under coordination of the two second annular inclined surfaces 242, thereby improving the imaging quality of the camera lens 1.

The lens group 20 further includes a fifth lens 25 arranged on an image side of the second lens 22. The camera lens 1 further includes a light shielding plate 70, which is located between the fifth lens 25 and the second lens 22. The light shielding plate 70 is used to absorb stray light generated between the fifth lens 25 and the second lens 22, and improve the imaging quality of the camera lens 1 on one hand, and is used to adjust a distance between the fifth lens 25 and the second lens 22 on the other hand. Meanwhile, in order to prevent the light on the second lens 22 from being irradiated to a fixing portion of the fifth lens 25 to generate stray light, in this embodiment, a fourth light shielding sheet 80 is arranged between the second lens 22 and the light shielding plate 70, and a fifth light shielding sheet 90 is arranged between the light shielding plate 70 and the fifth lens 25.

Preferably, the camera lens 1 further includes a pressure ring 100 arranged on an image side of the fifth lens 25 and located in the lens barrel 10. In this embodiment, each lens is fixed in the lens barrel 10 through the pressure ring 100, so that the camera lens 1 can be easily detached. Of course, in specific applications, each lens can also be fixed in the lens barrel 10 by adhesive.

It is understood that the lens group 20 is not limited to include the five lenses mentioned above. Specifically, the lens group can also include two (i.e., the lens group 20 merely includes the first lens 21 and the second lens 22) or three (i.e., the lens group 20 includes the first lens 21, the second lens 22 and the third lens 23) or four (i.e., the lens group 20 includes the first lens 21, the second lens 22, the third lens 23 and the fourth lens 24) or more than five lenses, which is determined according to the actual needs.

The embodiments of the present invention further provide an electronic device having image shooting function which includes the camera lens 1 mentioned above. Preferably, the electronic device having image shooting function is a mobile phone or a camera.

The description above is merely the embodiments of the present invention, and it should be pointed out that those of ordinary skills in the art may make improvements without departing from the concept of the present invention, and all these improvements shall belong to the scope of protection of the present invention.

What is claimed is:

1. A camera lens, comprising a lens barrel, a first lens, a second lens and a first light shielding sheet, wherein the first lens, the first light shielding sheet and the second lens are stacked in the lens barrel in sequence from an object side to an image side, the lens barrel has a first annular inclined surface surrounding a periphery of the first light shielding sheet, the first annular inclined surface is provided with a glue layer, and an outer edge of the first light shielding sheet is adhered to the glue layer.

2. The camera lens according to claim 1, wherein the camera lens further comprises a third lens arranged on an object side of the first lens and located in the lens barrel, and a second light shielding sheet is arranged between the third lens and the first lens.

3. The camera lens according to claim 2, wherein the camera lens further comprises a fourth lens arranged on an object side of the third lens and located in the lens barrel, and a third light shielding sheet is arranged between the fourth lens and the third lens.

4. The camera lens according to claim 3, wherein an outer edge of the object side of the third lens is provided with an annular recess, and outer edge of an image side of the fourth lens is provided with an annular lug boss, and the annular lug boss is clamped in the annular recess.

5. The camera lens according to claim 4, wherein the annular recess is defined by a side wall and a bottom wall, the side wall and the bottom wall are arranged outwards along a radial direction of the lens barrel, the side wall obliquely extends to the bottom wall in a manner of gradually away from a central line of the lens barrel, and the annular lug boss has a second annular inclined surface attached to the side wall.

6. The camera lens according to claim 5, wherein the camera lens further comprises a fifth lens arranged on an image side of the second lens and located in the lens barrel, and a fourth light shielding sheet is arranged between the second lens and the fifth lens.

7. The camera lens according to claim 6, wherein the camera lens further comprises a light shielding plate and a fifth light shielding sheet, and the light shielding plate and the fifth light shielding sheet are stacked between the fourth light shielding sheet and the fifth lens in sequence from the object side to the image side.

8. The camera lens according to claim 6, wherein the camera lens further comprises a pressure ring arranged on an image side of the fifth lens and located in the lens barrel.

9. An electronic device having image shooting function, comprising the camera lens according to claim 1.

10. The electronic device having image shooting function according to claim 9, wherein the electronic device is a mobile phone or a camera having image shooting function.
